(19) United States
(12) Patent Application Publication
(10) Pub. No.: US 2007/0159531 A1
(43) Pub. Date: Jul. 12, 2007

(54) Vehicle back seat monitoring apparatus

(76) Inventor: Margaret T. Anderson, Jackson, MS (US)

Correspondence Address: S. Michael Bender, P.O. Box 530399, St. Petersburg, FL, 33747, US

(21) Appl. No.: 11/651,304

(22) Filed: Jan. 9, 2007

Related U.S. Application Data
(60) Provisional application No. 60/757,487, filed on Jan. 10, 2006.

(51) Int. Cl. H04N 7/18

(52) U.S. Cl. 348/148

(57) ABSTRACT

A back seat monitoring apparatus is provided for a vehicle which includes a back seat, an interior ceiling, a dashboard, and a steering wheel. The subject apparatus includes a closed-circuit television camera mounted on the interior ceiling for viewing the back seat. A monitor screen is mounted in the vehicle for forward viewing by a driver of the vehicle who is sitting on the front seat. The monitor screen is electrically connected to the closed-circuit television camera. With the invention, the driver can safely face forward while observing the monitor screen which displays what is happening on the back seat. The closed-circuit television camera and the monitor screen are battery powered, preferably by the vehicle battery. Preferably, the monitor screen is mounted on the dashboard of the vehicle. An actuator switch, for activating the closed-circuit television camera and/or the monitor screen, can be mounted on the steering wheel of the vehicle.

### CROSS-REFERENCE TO RELATED APPLICATION

This application claims priority based upon my copending Provisional Application Ser. No. 60/757,487; filed Jan. 10, 2006.

### BACKGROUND OF THE INVENTION

1. Field of the Invention

The present invention relates generally to monitoring systems for vehicles and, more particularly, to vehicle monitoring systems especially adapted for monitoring the rear portion of the passenger compartment by the vehicle by the driver of the vehicle.

2. Description of the Prior Art

Often, the driver of a vehicle wishes to monitor the rear seats in the passenger compartment. This is especially so when the driver wishes to monitor children who are seated on the rear seats. In this respect, throughout the years, a number of innovations have been developed which permit monitoring the rear seats in a vehicle passenger compartment by the driver of the vehicle, and the following U.S. patents are representative of some of those innovations: 4,549,790, 5,453,882, and 5,576,898.

More specifically, each of U.S. Pat. Nos. 4,549,790, 5,453,882, and 5,576,898 discloses a rear seat monitoring system which includes one or more mirrors having the rear seats in view for the driver. It is well known that mirrors can be easily knocked out of alignment. Moreover, mirrors must be adjusted to accommodate the height of the driver. In view of the above, it would be desirable if a vehicle back seat monitoring device were provided which does not include mirrors.

As a matter of interest, U.S. Pat. No. 6,393,348 discloses a system which permits a driver to monitor specifically sensed body parameters of a passenger seated in the rear seat area. An electronic display is viewed by the driver. A number of sensors are attached to the passenger, and such sensors sense respiration, temperature, and heart rate. Although it is advantageous for a driver to be able to glance at an electronic display to monitor a passenger on a rear seat, it is not convenient to have sensors attached to a passenger, especially if the passenger is a child. In this respect, it would be desirable for a driver to be able to use an electronic display to monitor a passenger on a rear seat without having sensors attached to the passenger.

As a matter of interest, U.S. Pat. No. 6,507,779 discloses a system that senses positions of passengers in the rear seat of the passenger compartment of a vehicle. Optical sensors can be employed, and the optical sensors generate signals that are processed. The processed signals are use to automatically control air bags in the vehicle. The driver of the vehicle is not informed in this system. Actually, optical sensors to sense the positioning of the driver and a front seat passenger can also be processed with respect to automatic control of air bags. The fact that the driver is not informed as to the positioning of rear seat passengers makes this system inapplicable for a driver who wishes to observe the status of children seated in the rear seats of the vehicle. In this respect, it would be desirable if electronic sensing of the positioning of rear seat passengers could be processed to inform the driver of such passenger positioning.

Thus, while the foregoing body of prior art indicates it to be well known to use a system for a driver of a vehicle to observe the status of passengers seated in the rear seats, the prior art described above does not teach or suggest a vehicle back seat monitoring apparatus which has the following combination of desirable features: (1) does not include mirrors; (2) permits a vehicle driver to be able to use an electronic display to monitor passengers on rear seats without having sensors attached to the passengers; and (3) provides electronic sensing of the positioning of rear seat passengers that is processed to inform the driver of such passenger positioning. The foregoing desired characteristics are provided by the unique vehicle back seat monitoring apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a back seat monitoring apparatus for a vehicle which includes a back seat, an interior ceiling, a dashboard, and a steering wheel. The subject apparatus includes a closed-circuit television camera mounted on the interior ceiling for viewing the back seat. A monitor screen is mounted in the vehicle for forward viewing by a driver of the vehicle who is sitting on the front seat. The monitor screen is electrically connected to the closed-circuit television camera. With the invention, the driver can safely face forward while observing the monitor screen which displays what is happening on the back seat.

The closed-circuit television camera and the monitor screen are battery powered. Preferably, the closed-circuit television camera and the monitor screen are electrically connected to and powered by a vehicle battery.

Preferably, the monitor screen is mounted on the dashboard of the vehicle.

Preferably, an actuator switch is electrically connected between the closed-circuit television camera and the monitor screen for controlling operation of the monitor screen. If desired, the actuator switch can be mounted on the steering wheel.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved vehicle back seat monitoring apparatus which has all of the advantages of the prior art and none of the disadvantages.

It is another object of the present invention to provide a new and improved vehicle back seat monitoring apparatus which may be easily and efficiently manufactured and marketed.

It is a further object of the present invention to provide a new and improved vehicle back seat monitoring apparatus which is of durable and reliable construction.

An even further object of the present invention is to provide a new and improved vehicle back seat monitoring apparatus which is susceptible of a low cost of manufacture with regard to both materials and labor, and which accordingly is then susceptible of low prices of sale to the consuming public, thereby making such vehicle back seat monitoring apparatus available to the buying public.

Still yet a further object of the present invention is to provide a new and improved vehicle back seat monitoring apparatus which does not include mirrors.

Still another object of the present invention is to provide a new and improved vehicle back seat monitoring apparatus that permits a vehicle driver to be able to use an electronic display to monitor passengers on rear seats without having sensors attached to the passengers.

Yet another object of the present invention is to provide a new and improved vehicle back seat monitoring apparatus which provides electronic sensing of the positioning of rear seat passengers that is processed to inform the driver of such passenger positioning.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a first embodiment of the vehicle back seat monitoring apparatus of the invention installed in a vehicle.

FIG. 2 is an enlarged rear view of the closed-circuit television camera of the apparatus shown in FIG. 1 taken along line 2-2 of FIG. 1.

FIG. 3 is an enlarged rear view of the monitor screen and actuator switch of the apparatus shown in FIG. 1 taken along line 3-3 thereof.

FIG. 4 is an block diagram of the components of the embodiment of the invention shown in FIGS. 1-3.

FIG. 5 is a second embodiment of the vehicle back seat monitoring apparatus of the invention shown which includes two closed-circuit television cameras for monitoring two back seats.

### DESCRIPTION OF THE PREFERRED EMBODIMENT

With reference to the drawings, a new and improved vehicle back seat monitoring apparatus embodying the principles and concepts of the present invention will be described.

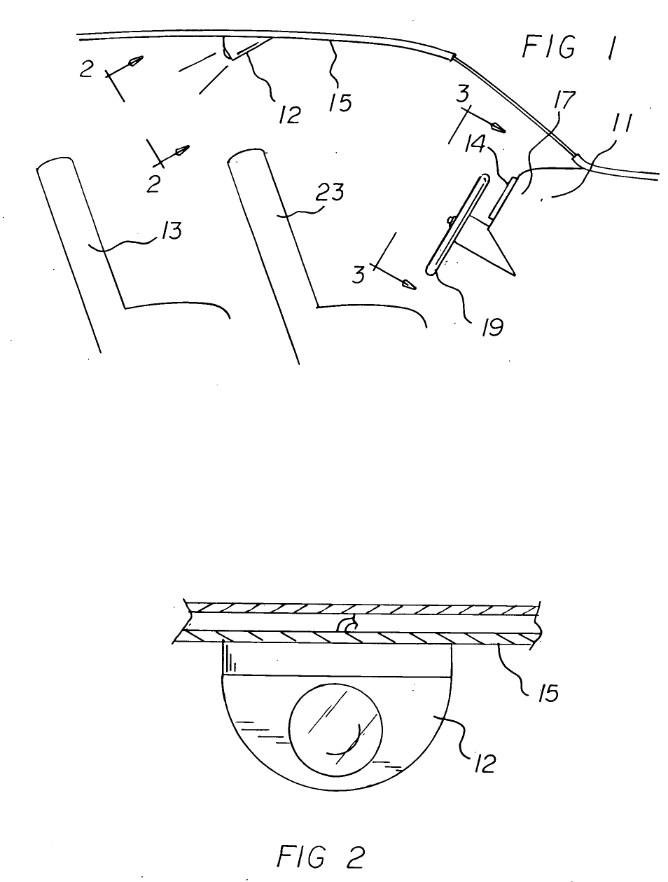

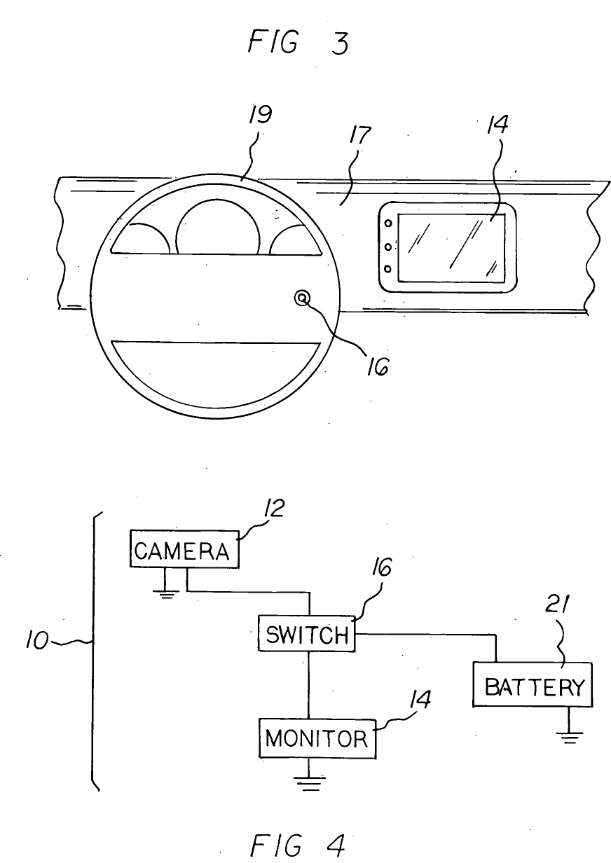

Turning to FIGS. 1-4, there is shown a first embodiment of the vehicle back seat monitoring apparatus of the invention generally designated by reference numeral 10, in FIG. 4. In each of the figures, reference numerals are shown that correspond to like reference numerals that designate like elements shown in other figures.

In the first embodiment, vehicle back seat monitoring apparatus 10 is provided for a vehicle 11 which includes a back seat 13, an interior ceiling 15, a dashboard 17, and a steering wheel 19. The subject apparatus includes a closed-circuit television camera 12 mounted on the interior ceiling 15 for viewing the back seat 13. A monitor screen 14 is mounted in the vehicle 11 for forward viewing by a driver of the vehicle 11 who is sitting on the front seat 23. The monitor screen 14 is electrically connected to the closed-circuit television camera 12.

The closed-circuit television camera 12 and the monitor screen 14 are battery powered. Preferably, the closed-circuit television camera 12 and the monitor screen 14 are electrically connected to and powered by a vehicle battery 21.

Preferably, the monitor screen 14 is mounted on the dashboard 17 of the vehicle 11.

Preferably, an actuator switch 16 is electrically connected between the closed-circuit television camera 12 and the monitor screen 14 for controlling operation of the monitor screen 14.

The actuator switch 16 can be mounted on the steering wheel 19.

To use the embodiment of the invention shown in FIGS. 1-4, the closed-circuit television camera 12 is aimed at the back seat 13 so that any persons or pets sitting on the back seat 13 are viewed by the closed-circuit television camera 12. Image signals from the closed-circuit television camera 12 are sent to the monitor screen 14 which is mounted on the dashboard 17 and faces the driver of the vehicle 11. With the driver of the vehicle 11 facing forward, the driver is able to look at the monitor screen 14 and observe what is happening on the back seat 13.

By using the actuator switch 16 mounted on the steering wheel 19, the driver can selectively turn on or turn off the monitor screen 14 and/or the closed-circuit television camera 12.

A significant advantage of using the vehicle back seat monitoring apparatus 10 of the invention is that the driver need not create a dangerous situation by turning around to face the back seat 13 in order to see what is happening on the back seat 13. Instead, with the invention, the driver can safely face forward while observing the monitor screen 14 which displays what is happening on the back seat 13.

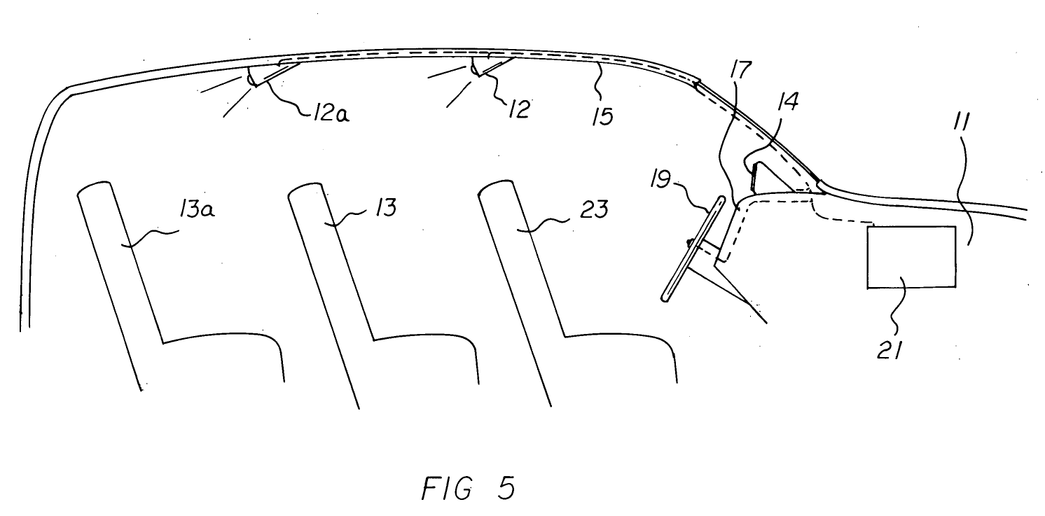

As shown in FIG. 5, a second embodiment of the invention shows a second closed-circuit television camera 12a which is used to monitor a second back seat 13a. Both the first closed-circuit television camera 12 and the second closed-circuit television camera 12a can be monitored on a single monitor screen 14 on a pair of side-by-side monitor screens 14.

The components of the vehicle back seat monitoring apparatus of the invention can be made from inexpensive and durable electronic components and wiring.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved vehicle back seat monitoring apparatus that is low in cost, relatively simple in design and operation, and which may advantageously be used without employing mirrors. With the invention, a vehicle back seat monitoring apparatus is provided which permits a vehicle driver to be able to use an electronic display to monitor passengers on rear seats without having sensors attached to the passengers. With the invention, a vehicle back seat monitoring apparatus provides electronic sensing of the positioning of rear seat passengers that is processed to inform the driver of such passenger positioning.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is Claimed as Being New and Desired to be Protected by Letters Patent of the United States is as Follows:

1. A back seat monitoring apparatus for a vehicle which includes a back seat, an interior ceiling, a dashboard, and a steering wheel, comprising:
a closed-circuit television camera mounted on the interior ceiling for viewing the back seat, and
a monitor screen mounted in the vehicle for forward viewing by a driver of the vehicle, wherein said monitor screen is electrically connected to said closed-circuit television camera.

2. The apparatus of claim 1 wherein said closed-circuit television camera and said monitor screen are battery powered.

3. The apparatus of claim 1 wherein said closed-circuit television camera and said monitor screen are electrically connected to and powered by a vehicle battery.

4. The apparatus of claim 1 wherein said monitor screen is mounted on the dashboard of the vehicle.

5. The apparatus of claim 1, further including:
an actuator switch electrically connected between said closed-circuit television camera and said monitor screen for controlling operation of said monitor screen.

6. The apparatus of claim 5 wherein said actuator switch is mounted on the steering wheel.
